(19) United States
(12) Patent Application Publication
(10) Pub. No.: US 2025/0362027 A1
(43) Pub. Date: Nov. 27, 2025

(54) PORTABLE-DEVICE SUPPORT SYSTEM

(71) Applicant: Cascade Designs, Inc., Seattle, WA (US)

(72) Inventors: Earl Gaylon SHERRARD, Ravensdale, WA (US); Joshua R. BUESSELER, Seattle, WA (US)

(21) Appl. No.: 19/225,988

(22) Filed: Jun. 2, 2025

Related U.S. Application Data
(63) Continuation of application No. 16/475,639, filed on Jul. 2, 2019, now Pat. No. 12,339,012.
(60) Provisional application No. 62/441,945, filed on Jan. 3, 2017.

(51) Int. Cl. F24C 3/14; A47J 36/26; A47J 36/34; F24C 1/16; F24C 3/02; F24C 15/08

(52) U.S. Cl. CPC F24C 3/14; A47J 36/26; A47J 36/34; F24C 1/16; F24C 3/027; F24C 15/086

(57) ABSTRACT

A portable-device support apparatus includes a surface element. First support elements are coupled to the surface element. Each first support element has an end proximal to the surface element and an end distal from the surface element. Second support elements are coupled to a respective first support element by a respective fastening device. Each fastening device can translate back and forth along a respective one of the first support elements between the proximal and distal ends. The apparatus has a deployed position in which each second support element extends at an angle from a first support element. The apparatus has a storage position.

### PRIORITY CLAIM

This application is a continuation of U.S. application Ser. No. 16/475,639 filed Jul. 2, 2019, which is a U.S. national phase entry of PCT Application No. PCT/US2017/069079 filed Dec. 29, 2017, which claims priority from and the benefit of U.S. Provisional Patent Application No. 62/441,945 filed Jan. 3, 2017, each of which is hereby incorporated by reference in its entirety as if fully set forth herein.

### BACKGROUND

Most legs on which portable devices, such as camping stoves or pots, are supported rotate around a vertical or horizontal axis from a storage position to the desired support position. Some are just removable for storage.

### DESCRIPTION OF THE DRAWING FIGURES

FIGS. 1-2 illustrate a portable-device support apparatus according to a first embodiment.

FIGS. 3-4 illustrate a portable-device support apparatus according to a second embodiment.

FIGS. 5-7 illustrate a portable-device support apparatus according to a third embodiment.

FIG. 8 illustrates a fuel canister and a portable-device support apparatus according to an embodiment.

FIGS. 9-10 illustrate a portable-device support apparatus according to a fourth embodiment.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

An embodiment includes support elements, such as legs, that move in a desired path for storage in a confined space. The deployed feet of the legs provide a relatively wide, stable platform to support a load/object, such as a pot. When deployed, the legs stay deployed.

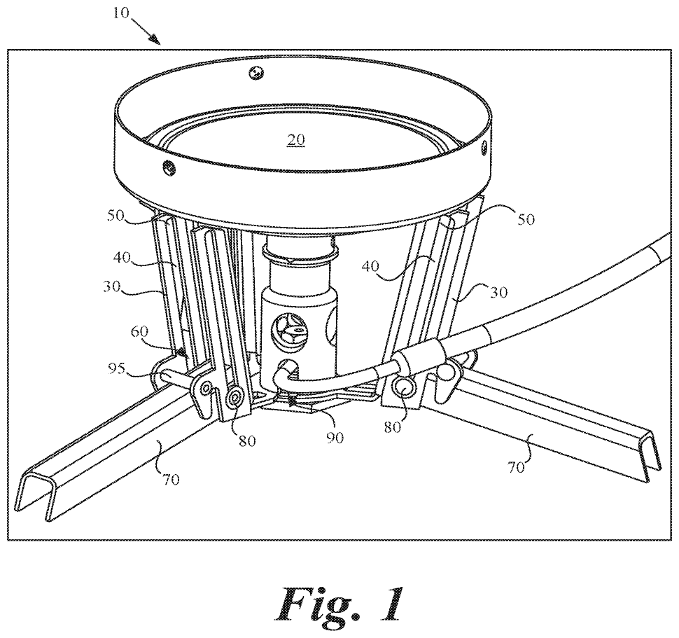

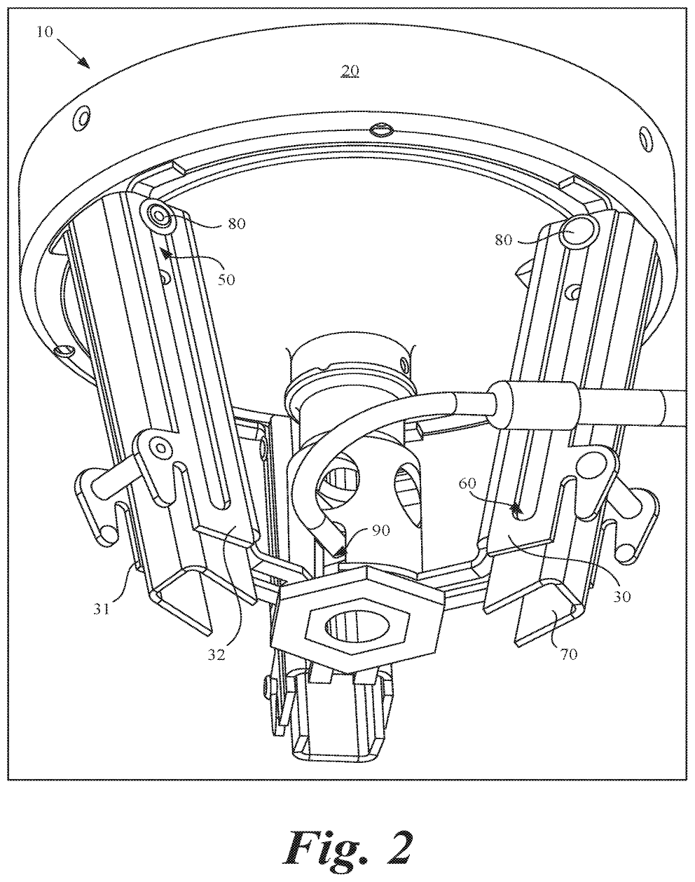

Referring now to FIGS. 1 and 2, shown is a portable-device support apparatus, such as a stove 10, according to a first embodiment of the invention. Stove 10 includes a surface element 20 on which, for example, a cooking pot may be placed for heating.

Stove 10 further includes a plurality of first support elements, such as mounts 30, coupled to the surface element 20. Each mount 30 may be directly coupled to the surface element 20. Each of the mounts 30 has one or more slot portions 40 formed therein. More specifically, each of the mounts 30 may include opposing walls 31, 32 within which the slot portions 40 are formed. Each slot portion 40 has an end 50 proximal to the surface element 20 and an end 60 distal from the surface element. Each slot portion 40 is closed at both the proximal and distal ends 50, 60.

Stove 10 further includes a plurality of second support elements, such as elongate legs 70 and a plurality of fastening devices, such as pins 80. Each leg 70 is coupled to a respective mount 30 by a respective one of the pins 80 positioned within respective slot portions 40. Each pin 80 is configured to translate back and forth within the slot portions 40 between the proximal and distal ends 50, 60. The translational movement of each pin 80 within each slot portion 40 is at least partially rectilinear.

As best shown in FIG. 1, stove 10 has a deployed position in which each pin 80 is at the distal end 60 and each leg 70 extends at an angle from the mount 30 to which each leg is coupled. Stove 10 may further include one or more rivets 95 that, when stove is in the deployed position, serves to stabilize and constrain the position of each leg 70. As best shown in FIG. 2, stove 10 has a storage position in which each pin 80 is at the proximal end 50 and at least a portion of each leg 70 is parallel with at least a portion of the mount 30 to which each leg is coupled. Alternatively, in the stored position each leg 70 is not parallel with at least a portion of the mount 30, but rather at a different angle with respect to the mount, possibly past parallel. When in this stored position, each leg 70 is disposed at least partially within a respective mount 30.

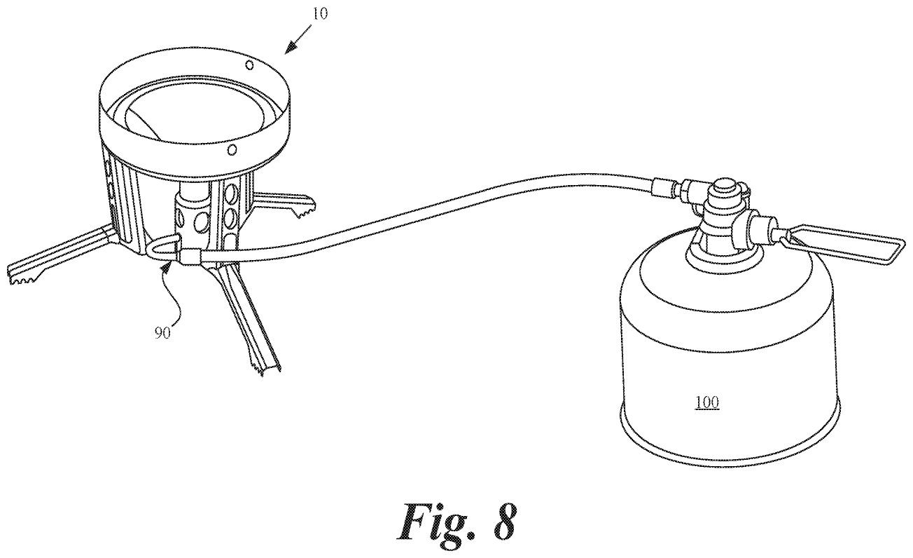

Stove 10 further includes a port assembly 90 configured to receive combustible fuel from a fuel source 100 as is best illustrated in FIG. 8. The surface element 20 may be fluidly coupled to the port assembly 90 and configured to combust the fuel received by the port assembly.

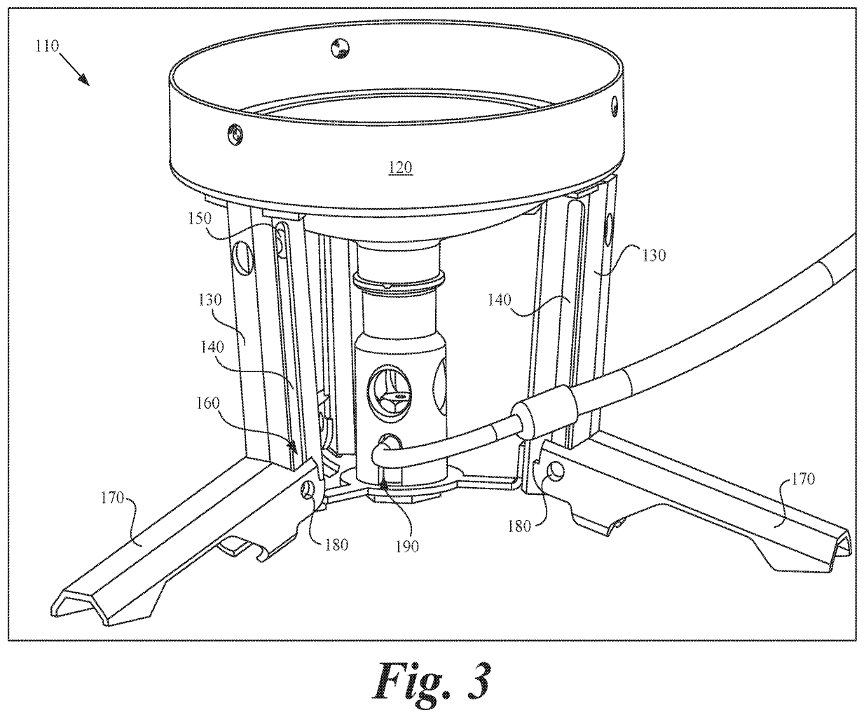

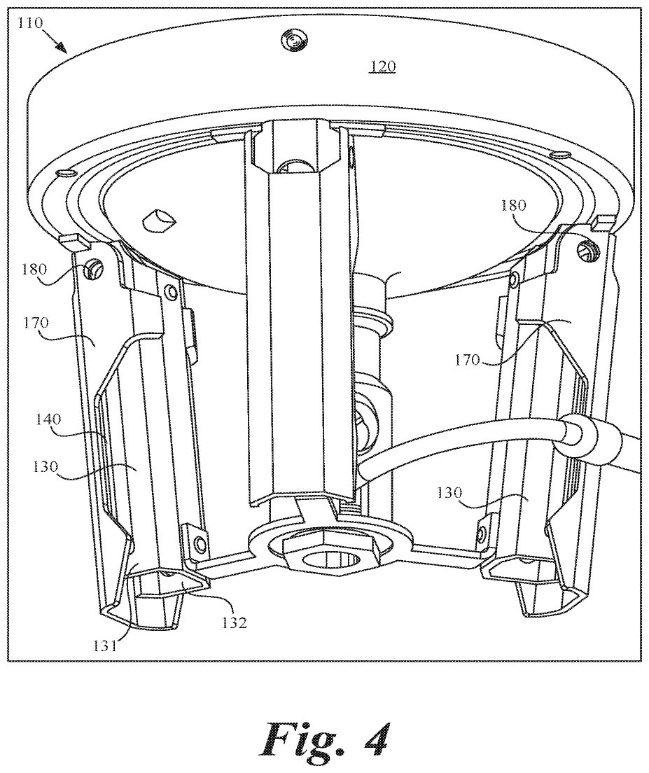

Referring now to FIGS. 3 and 4, shown is a portable-device support apparatus, such as a stove 110, according to a second embodiment of the invention. Stove 110 includes a surface element 120 on which, for example, a cooking pot may be placed for heating.

Stove 110 further includes a plurality of first support elements, such as mounts 130, coupled to the surface element 120. Each mount 130 may be directly coupled to the surface element 120. Each of the mounts 130 has one or more slot portions 140 formed therein. More specifically, each of the mounts 130 may include opposing walls 131, 132 within which the slot portions 140 are formed. Each slot portion 140 has an end 150 proximal to the surface element 120 and an end 160 distal from the surface element. Each slot portion 140 is closed at both the proximal and distal ends 150, 160.

Stove 110 further includes a plurality of second support elements, such as elongate legs 170 and a plurality of fastening devices, such as pins 180. Each leg 170 is coupled to a respective mount 130 by a respective one of the pins 180 positioned within respective slot portions 140. Each pin 180 is configured to translate back and forth within the slot portions 140 between the proximal and distal ends 150, 160. The translational movement of each pin 180 within each slot portion 140 is at least partially rectilinear.

As best shown in FIG. 3, stove 110 has a deployed position in which each pin 180 is at the distal end 160 and each leg 170 extends at an angle from the mount 130 to which each leg is coupled. As best shown in FIG. 4, stove 110 has a storage position in which each pin 180 is at the proximal end 150 and at least a portion of each leg 170 is parallel with at least a portion of the mount 130 to which each leg is coupled. When in this stored position, each mount 130 is disposed at least partially within a respective leg 170.

Stove 110 further includes a port assembly 190 configured to receive combustible fuel from a fuel source. The surface element 120 may be fluidly coupled to the port assembly 190 and configured to combust the fuel received by the port assembly.

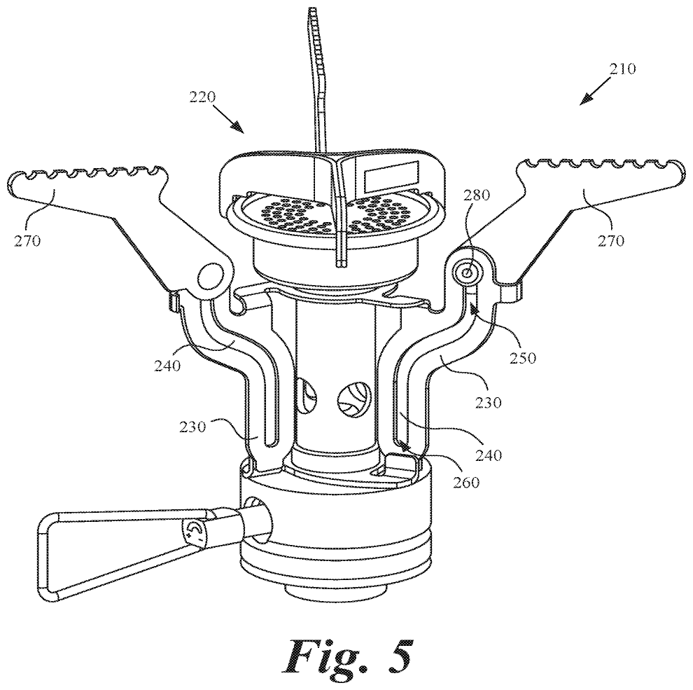

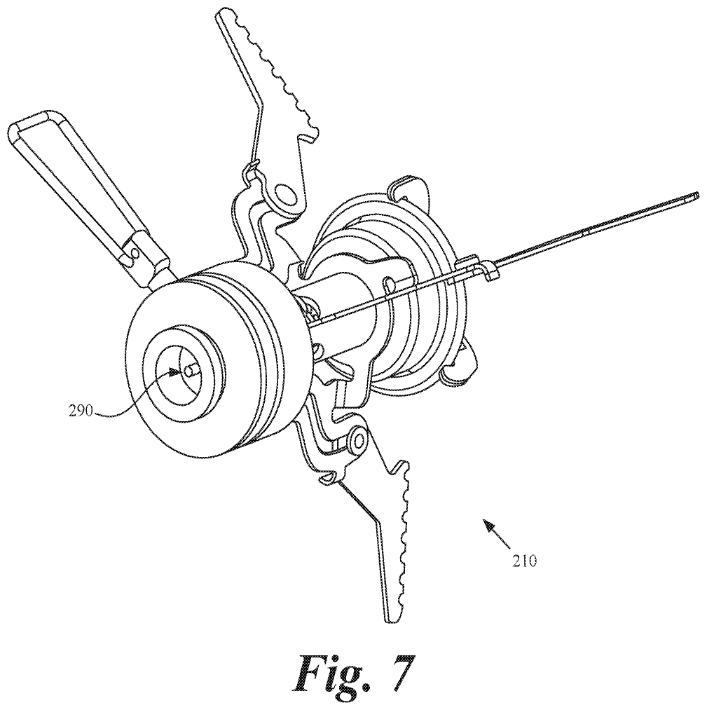

Referring now to FIGS. 5-7, shown is a portable-device support apparatus, such as a stove 210, according to a third embodiment of the invention. Stove 210 includes a surface element 220 over which, for example, a cooking pot may be placed for heating.

Stove 210 further includes a plurality of first support elements, such as mounts 230, coupled to the surface element 220. Each mount 230 may be directly coupled to the surface element 220. Each of the mounts 230 has one or more slot portions 240 formed therein. Each slot portion 240 has an end 250 proximal to the surface element 220 and an end 260 distal from the surface element. Each slot portion 240 is closed at both the proximal and distal ends 250, 260.

Stove 210 further includes a plurality of second support elements, such as elongate legs 270 and a plurality of fastening devices, such as pins 280. Each leg 270 is coupled to a respective mount 230 by a respective one of the pins 280 positioned within respective slot portions 240. Each pin 280 is configured to translate back and forth within the slot portions 240 between the proximal and distal ends 250, 260. The translational movement of each pin 280 within each slot portion 240 is at least partially curvilinear.

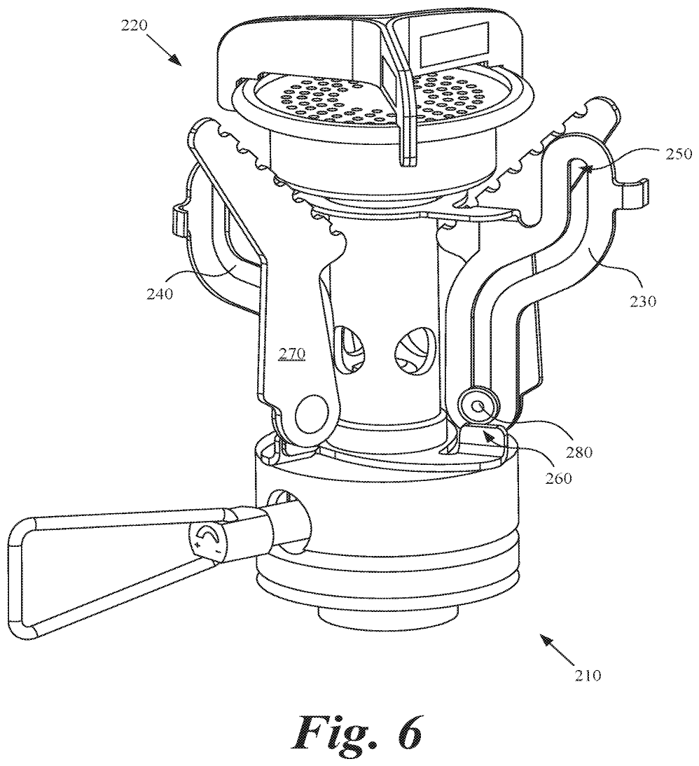

As best shown in FIG. 5, stove 210 has a deployed position in which each pin 280 is at the proximal end 250 and each leg 270 extends at an angle from the mount 230 to which each leg is coupled. As best shown in FIG. 6, stove 210 has a storage position in which each pin 280 is at the distal end 260 and at least a portion of each leg 270 is parallel with at least a portion of the mount 230 to which each leg is coupled.

Stove 210 further includes a port assembly 290 configured to receive combustible fuel from a fuel source. The surface element 220 may be fluidly coupled to the port assembly 290 and configured to combust the fuel received by the port assembly.

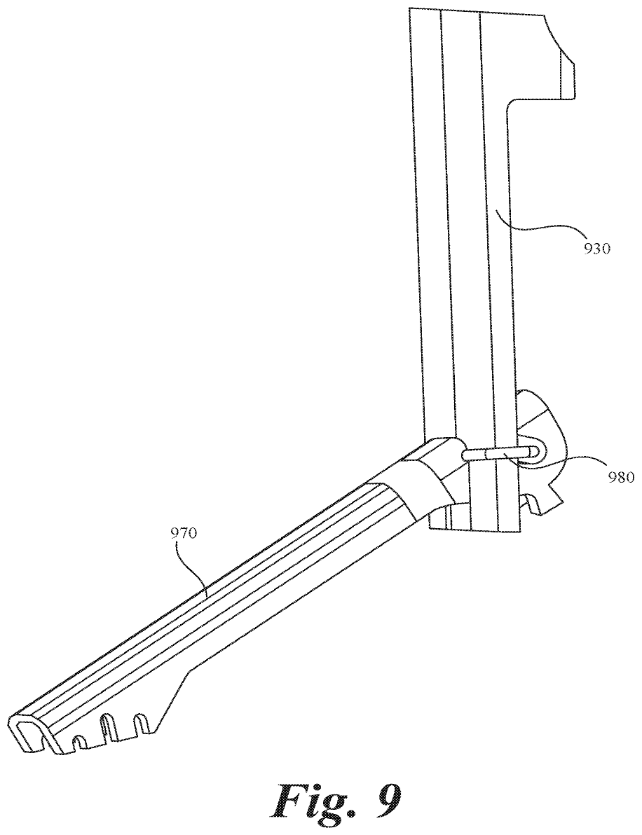

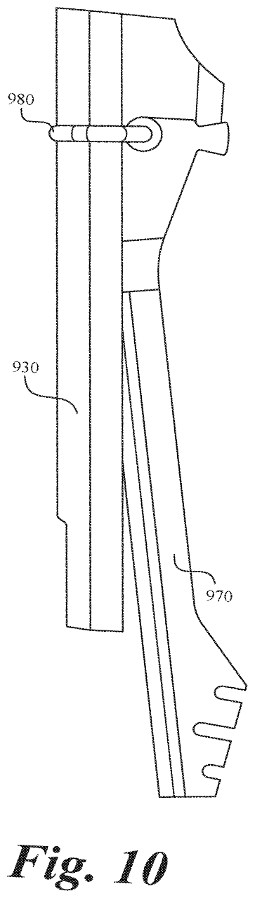

While the preferred embodiment of the invention has been illustrated and described, many changes can be made without departing from the spirit and scope of the invention. For example, the path of movement of the legs 70 need not be limited to movement within slot portions 40. In an embodiment, a rod coupled to the surface element 20 may set the path of movement of legs 70 with a hole in the legs into which the rod is inserted following such path. Additionally, referring to FIGS. 9 and 10 and in an alternative embodiment, pins 80 may be excluded; elements, such as followers 980, can be coupled to at least one of the mounts 930 and legs 970 and circumscribe the other of the mounts and legs to allow movement of the mounts and legs relative to each other. In an alternative embodiment, stove 10 could be configured such that the slot ends are equidistant from the surface element 20, without an identifiable distal or proximal end. Additionally, and in an embodiment, stove 10 may include springs that load the legs 70 into the deployed position. Accordingly, the scope of the invention is not limited by the disclosure of the preferred embodiment. Instead, the invention should be determined entirely by reference to the claims that follow.

1. (canceled)

2. A portable-device support system, comprising:
a partially hollow tube apparatus, wherein the tube apparatus further comprises:
a first end comprising a port;
one or more holes in a side of the tube apparatus; and
a second end comprising a surface configured to support placement of a cooking pot;
a plurality of movable support members, wherein each movable support member comprises:
a proximal end coupled to the tube apparatus via a pin, wherein the proximal end rotates along an axis of the pin; and
a distal end that freely moves with respect to the tube apparatus, and
the system having a deployed position in which a top of each of the distal ends of the plurality of movable support members are on a plane defined by a top of the surface of the tube apparatus, wherein a vector drawn from a center of the pin associated with one movable support member of the plurality of movable support members to a tip of the distal end of the one movable support member has a first angle with respect to the tube apparatus when in the deployed position, and
the system having a stowed position in which the distal ends of each of the plurality of movable support members are below the plane defined by the top of the surface of the tube apparatus, wherein the vector has a second angle with respect to the tube apparatus when in the stowed position.

3. The portable-device support system of claim 2, wherein the movement of the plurality of movable support members is at least partially rotational.

4. The portable-device support system of claim 2, wherein the tube apparatus comprises a plurality of flanges, and wherein each flange frictionally engages a respective one of the plurality of movable support members to arrest rotational movement of the plurality of movable support members in the deployed position.

5. The portable-device support system of claim 2, further comprising a knob, wherein the knob governs a size of an opening of the port.

6. The portable-device support system of claim 2, wherein the port is configured to introduce a first fluid to the tube apparatus, and wherein the one or more holes in the side of the tube apparatus is configured to introduce a second fluid to the tube apparatus.

7. The portable-device support system of claim 6, wherein the second end is fluidly coupled to the first end and the one or more holes in the side of the tube apparatus, and wherein the second end is configured to combust a mixture of the first fluid and the second fluid.

8. The portable-device support system of claim 2, wherein the tube apparatus includes a plurality of brackets, each bracket of the plurality of brackets having a slot for receiving the pin, the pin translating along the slot when each movable support member is moved between the deployed position and the stowed position.

9. The portable-device support system of claim 8, wherein the slot is curvilinear.

10. The portable-device support system of claim 9, wherein the slot is sinuous.
